(19) United States
(12) Patent Application Publication
(10) Pub. No.: US 2002/0132544 A1
(43) Pub. Date: Sep. 19, 2002

(54) Three-dimensional non-woven fabric, method for manufacturing the same, and mold for manufacturing the same

(75) Inventor: Takanari Takagaki, Kariya-shi (JP)

Correspondence Address: OLIFF & BERRIDGE, PLC, P.O. BOX 19928, ALEXANDRIA, VA, 22320, US

(73) Assignee: TOYODA BOSHOKU CORPORATION, Kariya-shi (JP)

(21) Appl. No.: 10/078,509

(22) Filed: Feb. 21, 2002

(30) Foreign Application Priority Data
Mar. 13, 2001 (JP) 2001-71208
Nov. 20, 2001 (JP) 2001-355018

(51) Int. Cl. D04H 1/00; D04H 3/00; D04H 5/00; D04H 13/00; B32B 5/26; B32B 27/02; B29C 43/22

(52) U.S. Cl. 442/381; 442/392; 442/400; 442/409; 264/505

(57) ABSTRACT

A three-dimensional non-woven fabric formed by spinning semi-molten fibers onto a mold. The three-dimensional non-woven fabric includes a hanging fiber wall formed from the semi-molten fibers hanging down from the mold in a tangled state.

### INCORPORATION BY REFERENCE

The disclosure of Japanese Patent Applications Nos. 2001-71208 filed on Mar. 13, 2001 and 2001-355018 filed on Nov. 20, 2001, each including the specification, drawings and abstract, are incorporated herein by reference in their entirety.

### BACKGROUND OF THE INVENTION

1. Field of Invention

The invention relates to a three-dimensional non-woven fabric formed by spinning semi-molten fibers onto a mold, and a method for manufacturing the same and a mold for manufacturing the same.

2. Description of Related Art

One way to efficiently form a three-dimensional non-woven fabric for use as a filter and the like is shown in FIGS. 17A and 17B. In this method, a spinning nozzle 94 spins semi-molten fibers F. Then the semi-molten fibers F are stacked onto a forming surface 92f of a forming mold 92 to form a three-dimensional non-woven fabric 90 having substantially the same shape as that of the forming surface 92f (see Japanese Patent Laid-Open Publication No. 8-38834).

The above method requires the forming mold 92 that has the forming surface 92f with substantially the same shape as that of the three-dimensional non-woven fabric 90. Therefore, the three-dimensional non-woven fabric 90 with a complicated shape needs to be formed with a complicated forming mold 92.

### SUMMARY OF THE INVENTION

The invention thus enables a three-dimensional non-woven fabric having a complicated shape to be formed with a simple mold. According to a first aspect of the invention, a three-dimensional non-woven fabric is formed by spinning semi-molten fibers onto a mold. This three-dimensional non-woven fabric includes at least one first portion formed from semi-molten fibers placed on a surface of a mold, and at least one second portion formed from semi-molten fibers hanging down from the at least one first portion in a tangled state, whereby the at least one second portion is formed in wall-shape.

According to the first aspect, the wall-shape second portion is formed from the semi-molten fibers hanging down from the first portion formed from semi-molten fibers placed on the surface of the mold in a tangled state. This eliminates the need for a surface (e.g., a vertical surface or a steeply inclined surface) for forming the wall-shape second portion. In other words, a surface such as a vertical surface or a steeply inclined surface can be eliminated from a forming surface of the mold. This enables simplification of a mold even if the three-dimensional non-woven fabric has a complicated shape.

According to a second aspect of the invention, a method for manufacturing a three-dimensional non-woven fabric includes the steps of preparing a mold including a portion for hanging fibers therefrom and spinning semi-molten fibers onto the mold so that the semi-molten fibers hang down from the mold to form a hanging fiber wall. Also, a three-dimensional non-woven fabric manufactured by the method of the second aspect falls within the scope of the invention.

According to a third aspect of the invention, a mold for manufacturing a three-dimensional non-woven fabric includes a member for hanging semi-molten fibers therefrom. Such a member simplifies the shape of the mold, enabling a three-dimensional non-woven fabric having a complicated shape to be manufactured. This mold may include a forming portion on which the semi-molten fibers are stacked. Also, a three-dimensional non-woven fabric manufactured by the mold of the third aspect falls within the scope of the invention.

### BRIEF DESCRIPTION OF THE DRAWINGS

The foregoing and further objects, features and advantages of the invention will become apparent from the following description of preferred exemplary embodiments with reference to the accompanying drawings, wherein like numerals are used to represent like elements and wherein:

FIG. 1A is a perspective view illustrating a method for manufacturing a three-dimensional non-woven fabric (filter) according to a first exemplary embodiment of the invention;

FIG. 1B is a longitudinal cross-sectional view taken along line IB-IB of FIG. 1A, showing the three-dimensional non-woven fabric during the manufacturing process;

FIG. 2 is a perspective view of the back surface of the filter according to the first exemplary embodiment of the invention;

FIG. 3 is a perspective view of a modification of a forming mold of the filter according to the first exemplary embodiment of the invention;

FIG. 4 is a perspective view of a forming mold for manufacturing a filter according to a second exemplary embodiment of the invention;

FIG. 5 is a cross-sectional view taken along line V-V of FIG. 4, illustrating a manufacturing process of the filter using the forming mold of FIG. 4 and the manufacturing facility of FIG. 1A;

FIG. 6 is a perspective view of the filter according to the second exemplary embodiment of the invention;

FIG. 7 is a perspective view of a first modification of the forming mold of the filter according to the second exemplary embodiment;

FIG. 8 is a perspective view of a second modification of the forming mold of the filter according to the second exemplary embodiment;

FIG. 9 is a perspective view of a filter formed with the forming mold of FIG. 8;

FIG. 10 is a cross-sectional view of the filter as viewed from the X direction of FIG. 9;

FIG. 11A is a schematic perspective view of a forming mold for manufacturing a filter according to a third exemplary embodiment of the invention;

FIG. 11B is a schematic perspective view of a filter and a manufacturing method thereof according to the third exemplary embodiment;

FIG. 12A is a cross-sectional view taken along line XIIA-XIIA of FIG. 11B, showing a main part of the filter and the forming mold;

FIG. 12B is a cross-sectional view of a main part of the filter separated from the forming mold of FIG. 12A;

FIG. 13A is a perspective view of a forming mold;

FIG. 13B is a perspective view of a filter;

FIG. 13C is a schematic longitudinal cross-sectional view of a spinning nozzle;

FIG. 14A is a perspective view illustrating a method for manufacturing a filter;

FIG. 14B is a cross-sectional view of a filter after the manufacturing process of FIG. 14A;

FIG. 15A is a perspective view of a first modification of the forming mold of the filter according to the third exemplary embodiment of the invention;

FIG. 15B is a cross-sectional view of both a filter formed with the forming mold of the first modification and the forming mold;

FIG. 16A is a perspective view of a second modification of the forming mold of the filter according to the third exemplary embodiment of the invention;

FIG. 16B is a cross-sectional view of both a filter formed with the forming mold of the second modification and the forming mold;

FIG. 17A is a perspective view illustrating a typical method for manufacturing a filter; and

FIG. 17B is a side view illustrating the manufacturing method as viewed from the XVIIB direction of FIG. 17A.

### DETAILED DESCRIPTION OF PREFERRED EMBODIMENTS

### First Exemplary Embodiment

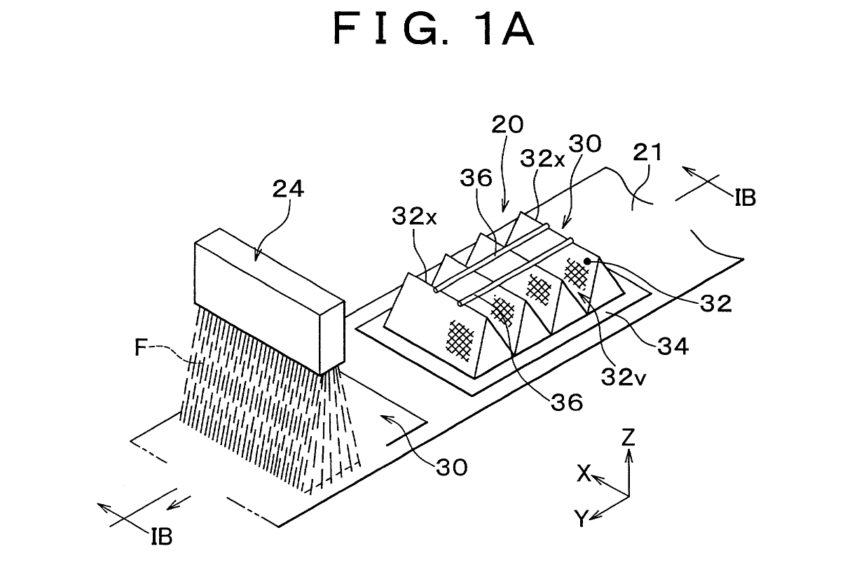

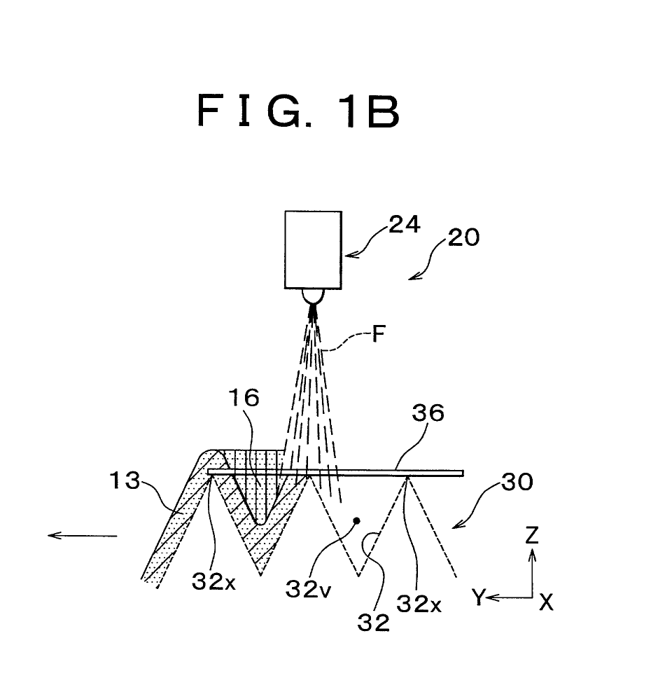

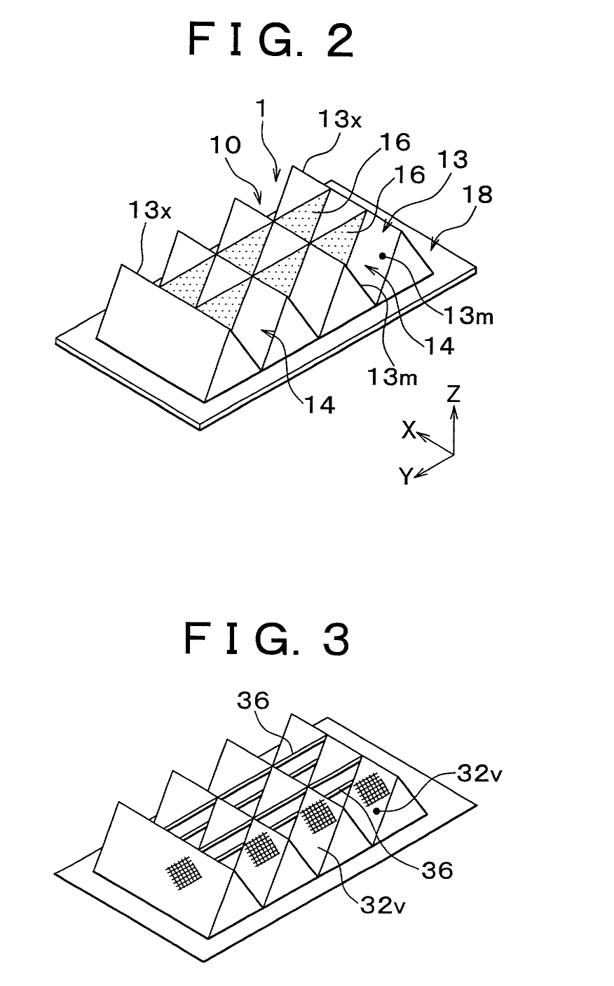

Hereinafter, a three-dimensional non-woven fabric and a manufacturing method thereof according to the first exemplary embodiment of the invention will be described with reference to FIGS. 1A to 3. The present embodiment relates to a method for manufacturing a filter as an example of the three-dimensional non-woven fabric. In FIG. 2, the X1 direction is the width direction of the filter, the Y1 direction is the longitudinal direction thereof, and the Z1 direction is the height direction thereof

As shown in FIG. 2, the filter 1 of the present embodiment includes a filtering portion 10 for filtering a fluid and a peripheral portion 18 formed around the filtering portion 10.

The filtering portion 10 is formed from a plurality of wave-shaped portions 13. More specifically, the plurality of wave-shaped portions 13 are arranged side-by-side and connected together to form the filtering portion 10. Each wave-shaped portion 13 has a shape of a substantially triangular prism. For simplicity, the filtering portion 10 includes four wave-shaped portions 13 in the figure. However, the filtering portion 10 may include five or more wave-shaped portions 13. Each wave-shaped portion 13 of the filtering portion 10 is formed like an opened container. In other words, each wave-shaped portion 13 is opened on the side (not shown) facing the peripheral portion 18 of the filter 1.

The filtering portion 10 has V-grooves 14 at its back surface. Each V-groove 14 is formed by respective inclined surface 13m of adjacent wave-shaped portions 13. A pair of substantially triangular partition walls 16 divide each V-groove 14 into three parts in the width direction (X direction) of the filter 1. The partition walls 16 are substantially triangular vertical walls to prevent deformation of the wave-shaped portions 13 in the Y direction (the longitudinal direction of the filter 1). The partition walls 16 extend perpendicular to the ridges 13x of the wave-shaped portions 13.

The partition walls 16 arranged within the V-grooves 14 prevent the respective inclined surfaces 13m of adjacent wave-shaped portions 13 from getting close to or away from each other. The partition walls 16 thus prevent the respective inclined surfaces 13m of adjacent wave-shaped portions 13 from even partially adhering to each other due to a negative pressure of the fluid passing through the filtering portion 10. This suppresses an increase in resistance to the fluid passing through the filtering portion 10.

The filter 1 is attached within a housing (not shown) with its peripheral portion 18 being held by a holding portion of the housing.

Hereinafter, a facility for manufacturing the filter 1 will be described briefly with reference to FIGS. 1A and 1B. Thereafter, a method for manufacturing the filter 1 by using that facility will be described.

The filter manufacturing facility 20 includes a horizontal conveyor 21. A plurality of forming molds 30 (only one forming mold is shown in FIG. 1A) are sequentially arranged on the conveyor 21. It is herein assumed that the X2 direction is the width direction of the conveyor 21, the Y2 direction is the traveling direction thereof, and the Z2 direction is the height direction thereof

The forming mold 30 has a first forming surface 32 for forming the filtering portion 10 of the filter 1, and a second forming surface 34 for forming the peripheral portion 18 of the filter 1. The first forming surface 32 for forming the filtering portion has the same shape as that of the front surface of the filtering portion 10 (i.e., the surface opposite to that having the partition walls 16). The second forming surface 34 for forming the peripheral portion has the same shape as that of the surface of the peripheral portion 18. Each of the first forming surface 32 for forming the filtering portion and the second forming surface 34 for forming the peripheral portion is formed from a permeable material such as wire mesh. Line-shaped members 36 are mounted on the ridges 32x of the first forming surface 32 for forming the filtering portion of the forming mold 30 at the positions corresponding to the partition walls 16. More specifically, two line-shaped members 36 are mounted at a prescribed distance therebetween on the ridges 32x of the first forming surface 32 for forming the filtering portion. The two line-shaped members 36 extend in parallel with each other and perpendicular to the ridges 32x (that is, in the Y2 direction).

A spinning nozzle 24 is mounted at a prescribed position above the conveyor 21. For example, the spinning nozzle 24 is a nozzle based on a melt-blow method. More specifically, the spinning nozzle 24 spins fibrous resin F (hereinafter, referred to as fibers F) injected from a not-shown extruder onto the first forming surface 32 for forming the filtering portion and the second forming surface 34 for forming the peripheral portion of the forming mold 30. The spinning nozzle 24 spins semi-molten fibers F. These semi-molten fibers F are thus stacked on the first forming surface 32 for forming the filtering portion and the second forming surface 34 for forming the peripheral portion and the like. As a result, the fibers F contact each other and are thus fusion-bonded into a non-woven fabric.

Hereinafter, a method for manufacturing the filter 1 will be described.

First, while the spinning nozzle 24 is spinning the fibers F at a substantially constant rate, the conveyor 21 is driven at a constant speed so that the forming mold 30 passes under the spinning nozzle 24 at a constant speed. As a result, as shown in FIG. 1B, the semi-molten fibers F are stacked with a substantially constant thickness on the first forming surface 32 for forming the filtering portion and the second forming surface 34 for forming the peripheral portion of the forming mold 30 successively from the leading end of the Y direction (i.e., the left end in the figure). The line-shaped members 36 of the forming mold 30 are entwined with the fibers F. Moreover, the fibers F become tangled on each other. As a result, the fibers F hang down from the line-shaped members 36, forming substantially triangular, hanging fiber walls between the line-shaped members 36 and V-groove portions 32v of the first forming surface 32 for forming the filtering portion.

Note that the hanging fiber walls have a thickness smaller than that of the fibers F stacked on the first forming surface 32 for forming the filtering portion and the like.

The fibers F stacked on the first forming surface 32 for forming the filtering portion of the forming mold 30, the fibers F hanging down from the line-shaped members 36 and the fibers F stacked on the second forming surface 34 for forming the peripheral portion contact each other and are thus fusion-bonded into a non-woven fabric. The non-woven fabric of the fibers F stacked on the first forming surface 32 for forming the filtering portion corresponds to the wave-shaped portions 13 of the filtering portion 10 of the filter 1. The non-woven fabric of the fibers F hanging down from the line-shaped members 36 (i.e., the hanging fiber walls) corresponds to the partition walls 16 of the filtering portion 10. The non-woven fabric of the filters F stacked on the second forming surface 34 for forming the peripheral portion corresponds to the peripheral portion 18. In this way, spinning semi-molten fibers F from the spinning nozzle 24 onto the forming mold 30 enables the wave-shaped portions 13, the partition walls 16 and the peripheral portion 18 to be formed integrally.

The filter 1 thus formed is removed from the forming mold 30. A finishing process is then conducted to complete the filter 1. The line-shaped members 36 are left within the partition walls 16 of the filter 1.

According to the method for manufacturing the filter according to the present embodiment, the semi-molten fibers F hanging down from the line-shaped members 36 of the forming mold 30 get tangled each other to form the partition walls 16 of the filter 1. This eliminates the need for a forming surface (e.g., a vertical surface or a steeply inclined surface) for forming the partition walls 16. In other words, a surface such as a vertical surface or a steeply inclined surface can be eliminated from the first forming surface 32 for forming the filtering portion of the forming mold 30. This enables a simplified forming mold 30 to be implemented even if the filter 30 having a complicated shape is to be formed.

The filtering portion 10 is formed from the plurality of wave-shaped portions 13 and the partition walls 16 extending perpendicular thereto. The partition walls 16 prevent the wave-shaped portions 13 of the filtering portion 10 from coming close to each other. In other words, the partition walls 16 prevent the wave-shaped portions 13 from even partially adhering to each other due to a negative pressure of the fluid passing through the filtering portion 10. This suppresses increase in resistance to the fluid passing through the filtering portion 10.

Note that, in the present embodiment, the line-shaped members 36 are arranged on top of the V-groove portions 32v of the first forming surface 32 for forming the filtering portion so that the fibers F hang down from the line-shaped members 36 to form the partition walls 16. As shown in FIG. 3, however, the line-shaped members 36 may be formed not only on the uppermost portion of the V-groove portions 32v but also below the uppermost portion of the V-groove portions 32v so that the fibers F hang down from the line-shaped members 36 to form the partition walls 16. Alternatively, a vertical mesh (not shown) may be mounted in each V-groove portion 32v so that the fibers F hang down from the vertical meshes to form the partition walls 16.

In the present embodiment, the filter 1 is finally removed from the forming mold 30. However, in the case where a light-weight forming mold 30 is used, the forming mold 30 may be integrated with the filter 1 so that the forming mold 30 is used as a framework of the filter. This improves the strength of the filter 1.

### Second Exemplary Embodiment

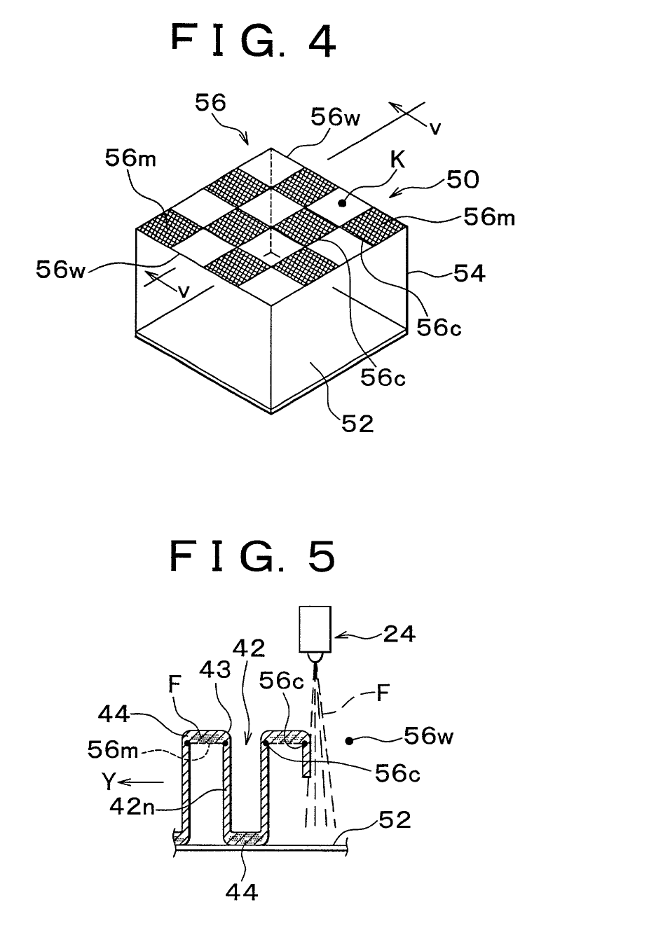

Hereinafter, a three-dimensional non-woven fabric and a manufacturing method thereof according to the second exemplary embodiment of the invention will be described with reference to FIGS. 4 to 10. The present embodiment relates to a method for manufacturing a filter as an example of the three-dimensional non-woven fabric.

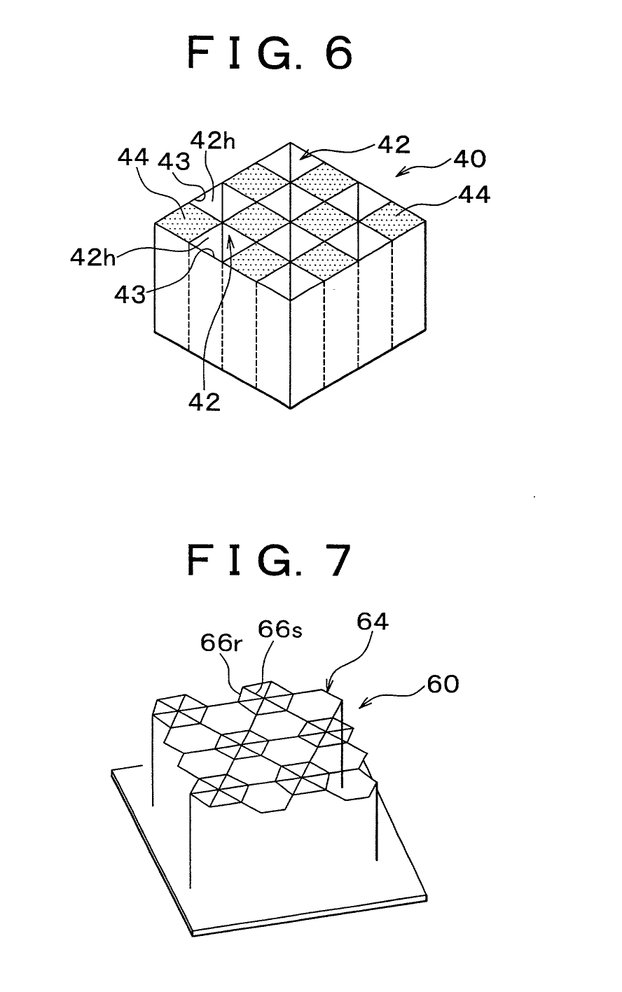

As shown in FIG. 6, a filter 40 has a honeycomb structure. More specifically, the filter 40 is formed from a plurality of polygonal columnar portions (in the figure, rectangular columnar portions 42). The plurality of rectangular columnar portions 42 are connected together with their sidewalls shared with each other. Each rectangular columnar portion 42 is formed like a bottomed container having its one end opened, and is formed from a main body 42h, an opening 43 and a bottom 44. The rectangular columnar portions 42 are arranged such that the respective openings 43 and bottoms 44 of adjacent rectangular columnar portions 42 are located opposite to each other. In this state, the rectangular columnar portions 42 are connected together with their sidewalls shared with each other. In other words, the openings 43 and bottoms 44 of the rectangular columnar portions 42 are alternately arranged at the top surface and bottom surface (not shown) of the filter 40.

Thus, the filter 40 has a honeycomb structure. Therefore, the filter 40 has an improved strength, and thus is less likely to be deformed by the negative pressure of the filter passing therethrough.

Hereinafter, a forming mold 50 for forming the filter 40 will be described with reference to FIG. 4.

The forming mold 50 includes a bottom plate 52, line-shaped columns 54 mounted at the four corners of the bottom plate 52, and a grid-like forming portion 56 retained substantially horizontally on the upper ends of the columns 54. The forming portion 56 is formed from a rectangular outer frame 56w, line-shaped members 56c partitioning the space within the outer frame 56w into a grid shape, and polygonal meshes (in the figure, rectangular meshes 56m). The rectangular meshes 56m are arranged in the grid formed by the outer frame 56w and the line-shaped members 56c. In other words, the rectangular meshes 56m are arranged such that openings K and the rectangular meshes 56m are arranged alternately.

Hereinafter, a method for manufacturing the filter 40 will be described with reference to FIG. 5. Note that, since the facility for manufacturing the filter 40 is the same as the facility 20 described in the first embodiment except for the forming mold 50, description thereof is omitted.

First, while the spinning nozzle 24 is spinning the fibers F at a substantially constant rate, the conveyor 21 is driven at a constant speed so that the forming mold 50 passes under the spinning nozzle 24 at a constant speed.

As a result, as shown in FIG. 5, semi-molten fibers F are stacked with a constant thickness on the rectangular meshes 56m of the forming portion 56 of the forming mold 50 successively from the leading end of the Y2 direction (i.e., the left end in the figure). Moreover, in the outer frame 56w of the forming portion 56 and the openings K, the outer frame 56w and the line-shaped members 56c at the opening edges are entwined with the fibers F. The fibers F thus hanging down from the outer frame 56w and the line-shaped members 56c and the like become tangled on each other, forming hanging fiber walls having a shape of a rectangular column. Moreover, the fibers F passing through the openings K are stacked with a constant thickness on the top surface of the bottom plate 52 of the forming mold 50 to close the hanging fiber walls at the lower end.

The fibers F stacked on the rectangular meshes 56m of the forming mold 50, the fibers F hanging down from the line-shaped members 56c and the like of the forming mold 50 (hanging fiber walls) and the fibers F stacked on the top surface of the bottom plate 52 of the forming mold 50 are fusion-bonded to each other into a non-woven fabric. The non-woven fabric of the fibers F stacked on the rectangular meshes 56m corresponds to the bottoms 44 at the top surface of the filter 40 (see FIG. 6). The non-woven fabric of the fibers F hanging down from the line-shaped members 56c and the like (hanging fiber walls) corresponds to the rectangular columnar portions 42 of the filter 40. The non-woven fabric of the fibers F stacked on the top surface of the bottom plate 52 corresponds to the bottoms 44 at the bottom surface of the filter 40. The openings K in the grid of the forming mold 50 can be regarded as a closed loop of the invention, and the forming portion 56 of the forming mold 50 can be regarded as a first plate member of the invention.

The filter 40 thus formed is removed from the forming mold 50. A finishing process is then conducted to complete the filter 40. Note that the columns 54 of the forming mold 50 may be detachable from the bottom plate 52. In this case, the columns 54 and the forming portion 56 may be integrated with the filter 40 so that they are used as a framework of the filter 40.

Thus, the rectangular columnar portions 42 of the filter 40 can be formed from the fibers F hanging down from the line-shaped members 56c and the like. Accordingly, the forming mold need not have a vertical surface for forming the rectangular columnar portions 42, thereby significantly simplifying the forming mold.

In the present embodiment, the filter 40 has a honeycomb structure. The filter 40 is formed from a plurality of columnar portions 42 having a rectangular cross section, and the columnar portions 42 are connected together with their sidewalls shared with each other. However, by using a forming mold 60 of FIG. 7, a filter having a honeycomb structure can be formed from a plurality of columnar portions having a hexagonal cross section. In this case as well, the columnar portions are connected together with their sidewalls shared with each other. In the forming mold 60 of FIG. 7, radial line-shaped members 66s arranged in hexagonal closed loops 66r have the same function as that of the rectangular meshes 56m of FIG. 4. Note that a plurality of line-shaped members may be arranged in parallel with each other instead of the radial line-shaped members 66s. The forming portion 64 of FIG. 7 can be regarded as a mesh-like member of the invention.

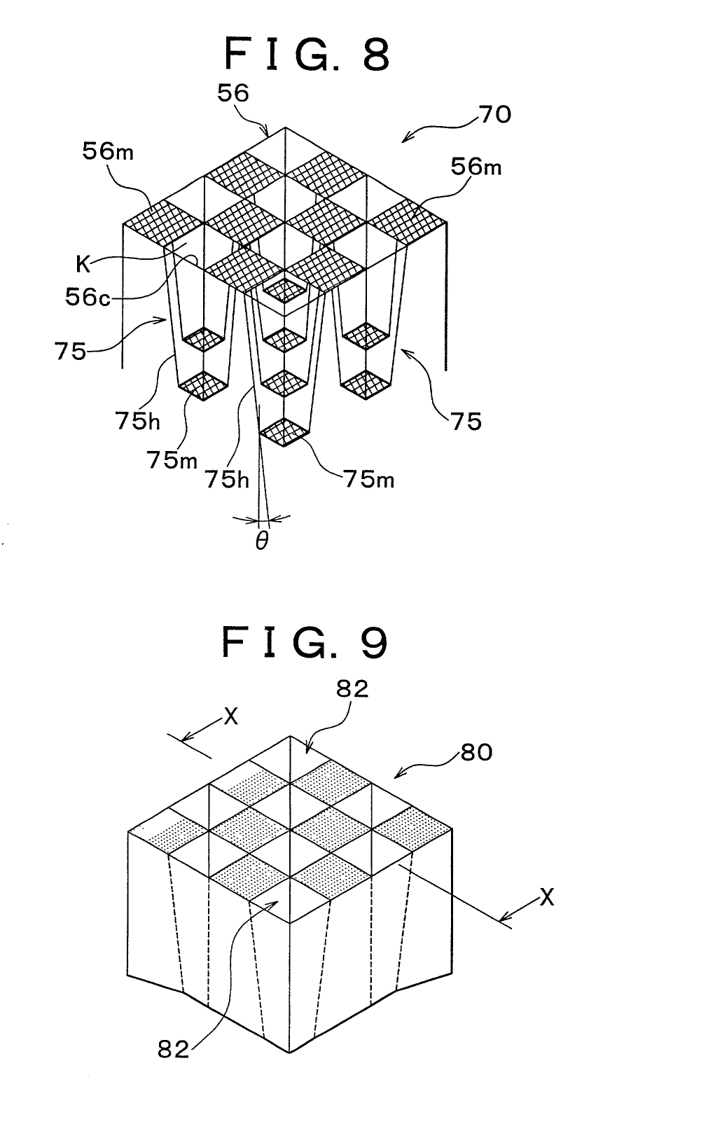

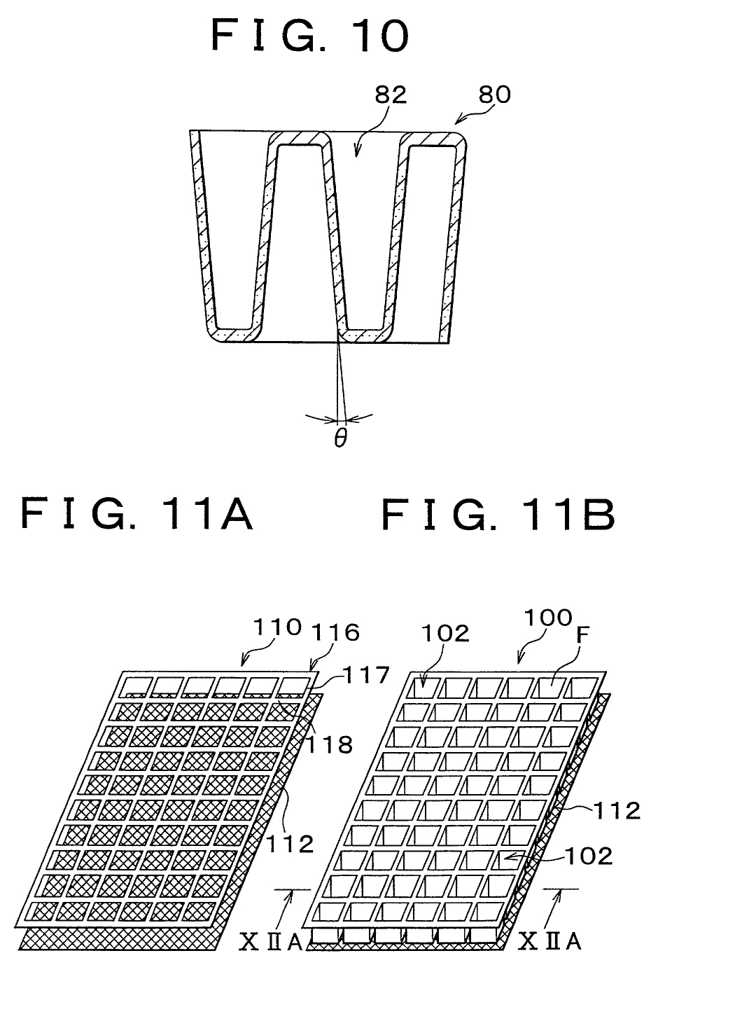

In the present embodiment, the filter 40 is formed so that the dimension inside the rectangular columnar portions 42 is constant in the vertical direction. Alternatively, a forming mold 70 of FIG. 8 may be used as a modification of the present embodiment. In this case, a filter 80 can be formed so that the dimension inside rectangular columnar portions 82 varies in the vertical direction, as shown in FIGS. 9 and 10.

The forming mold 70 corresponds to the forming mold 50 of FIG. 4 additionally including suspended portions 75 at the positions of the openings K.

Each suspended portion 75 is formed from a lower rectangular mesh 75m and four line-shaped support columns 75h supporting the lower rectangular mesh 75m horizontally. The line-shaped support columns 75h have their respective upper ends connected to the four corners of the corresponding opening K in the forming portion 56, respectively. The area of the lower rectangular mesh 75m is smaller than that of the opening K in the forming portion 56. Therefore, each suspended portion 75 formed from the four line-shaped support columns 75h and the lower rectangular mesh 75m has a shape of an inverted truncated pyramid.

As the semi-molten fibers F are spun onto the forming mold 70, they are stacked with a constant thickness on the rectangular meshes 56m (upper rectangular meshes 56m) of the forming mold 70 successively from the leading end. Moreover, in the openings K, the line-shaped members 56c at the opening edges are entwined with the fibers F. The fibers F thus hanging down from the line-shaped members 56c and the like are tangled with each line-shaped support column 75h of the suspended portions 75, forming hanging fiber walls having a shape of a tapered, rectangular column. Moreover, the fibers F passing through the openings K are stacked with a constant thickness on the lower rectangular meshes 75m of the suspended portions 75 to close the hanging fiber walls at the lower end. As a result, an integral filter 80 can be formed so that the dimension inside the rectangular columnar portion 82 varies in the vertical direction (see FIGS. 9 and 10).

By varying the angle θ of the line-shaped support column 75h from the vertical line, the tilt angle θ of the sidewall of the rectangular columnar portion 82 can also be varied.

### Third Exemplary Embodiment

Hereinafter, a three-dimensional non-woven fabric and a manufacturing method thereof according to the third exemplary embodiment of the invention will be described with reference to FIGS. 11A to 16B. The present embodiment relates to a method for manufacturing a filter as an example of the three-dimensional non-woven fabric.

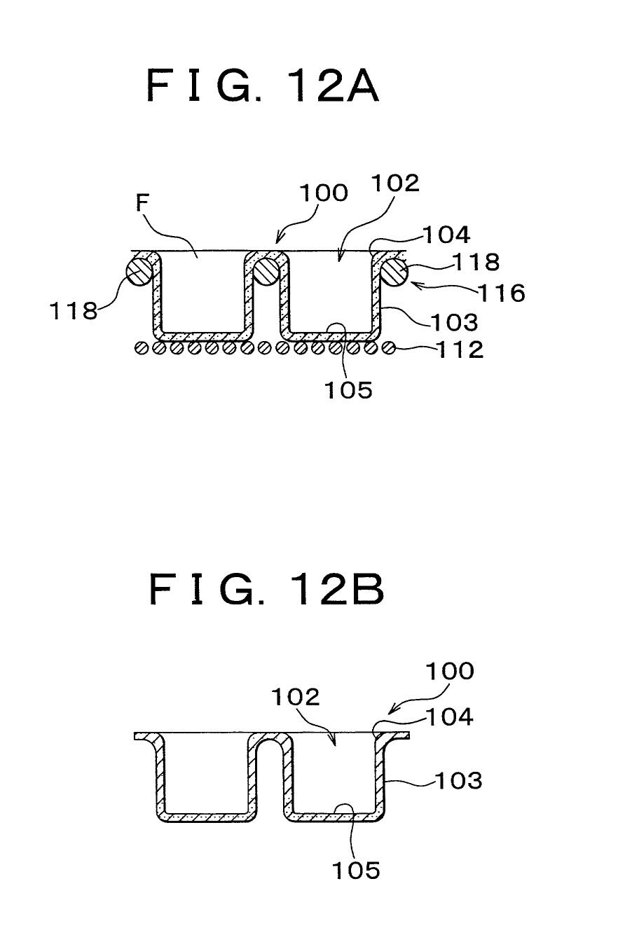

As shown in FIGS. 11B, 12A and 12B, the filter 100 of the present embodiment includes a plurality of polygonal columnar portions (in the figures, rectangular columnar portions 102). The rectangular columnar portions 102 are connected together at their opening edges. Each rectangular columnar portion 102 is formed like a bottomed container having its one end opened, and is formed from a main body 103, an opening 104 and a bottom 105. The filter 100 is thus formed from the plurality of rectangular columnar portions 102 connected together at their opening edges. Therefore, the filter 100 has an improved strength and thus is less likely to be deformed by the negative pressure of the fluid passing therethrough.

Hereinafter, a forming mold 110 for forming the filter 100 will be described with reference to FIG. 11A. The forming mold 110 includes a flat bottom plate 112 and a grid-like forming portion 116 arranged in parallel therewith. The bottom plate 112 is formed a from a permeable, fine mesh material such as wire mesh. The forming portion 116 is formed from a rectangular outer frame 117 and line-shaped members 118 partitioning the space within the outer frame 117 into a grid shape. In order to prevent the hanging fiber walls formed inside and outside each line-shaped member 118 from contacting each other, the diameter of the line-shaped members 118 is larger than that of the line-shaped members 56c of the forming mold 50 of the second embodiment. The distance from the bottom plate 112 to the forming portion 116 is determined according to the length of the rectangular columnar portions 102 of the filter 100. The forming portion 116 can be regarded as a mesh-like member of the invention. Note that a mechanism for retaining the forming portion 116 in parallel with the bottom plate 11 at a prescribed height is not shown in the figure.

Hereinafter, a method for manufacturing the filter 100 will be described. Note that since the facility for manufacturing the filter 100 is the same as the facility 20 described in the first embodiment except for the forming mold 110, description thereof is omitted.

First, while the spinning nozzle 24 is spinning the fibers F at a substantially constant rate, the conveyor 21 is driven at a constant speed so that the forming mold 110 passes under the spinning nozzle 24 at a constant speed.

As a result, semi-molten fibers F are supplied to the forming mold 110 successively from the leading end of the Y2 direction. The outer frame 117 and the line-shaped members 118 in the forming portion 116 are entwined with the fibers F. The fibers F thus hanging down from the outer frame 117 and the line-shaped members 118 become tangled to each other, forming hanging fiber walls having a shape of a rectangular column. Moreover, the fibers F passing through the forming portion 116 are stacked with a constant thickness on the top surface of the bottom plate 112 of the forming mold 110 to close the hanging fiber walls at the lower end. The fibers F tangled with the outer frame 117 and the line-shaped members 118, the fibers F of the hanging fiber walls and the fibers F stacked on the bottom plate 112 are fusion-bonded to each other into a non-woven fabric.

The non-woven fabric of the hanging fiber walls corresponds to the main bodies 103 of the plurality of rectangular columnar portions 102 of the filter 100. The non-woven fabric of the fibers F stacked on the top surface of the bottom plate 112 corresponds to the bottoms 105 of the rectangular columnar portions 102. The non-woven fabric of the fibers F stacked (tangled with) the outer frame 117 and the line-shaped members 118 of the forming portion 116 corresponds to the opening edges of the rectangular columnar portions 102. As described above, the line-shaped members 118 of the forming mold 110 have a relatively large diameter. Therefore, the outer side surfaces of adjacent rectangular columnar portions 102 will not contact each other.

As shown in FIG. 12B, the filter 100 thus formed is removed from the forming mold 110. A finishing process is then conducted to complete the filter 100.

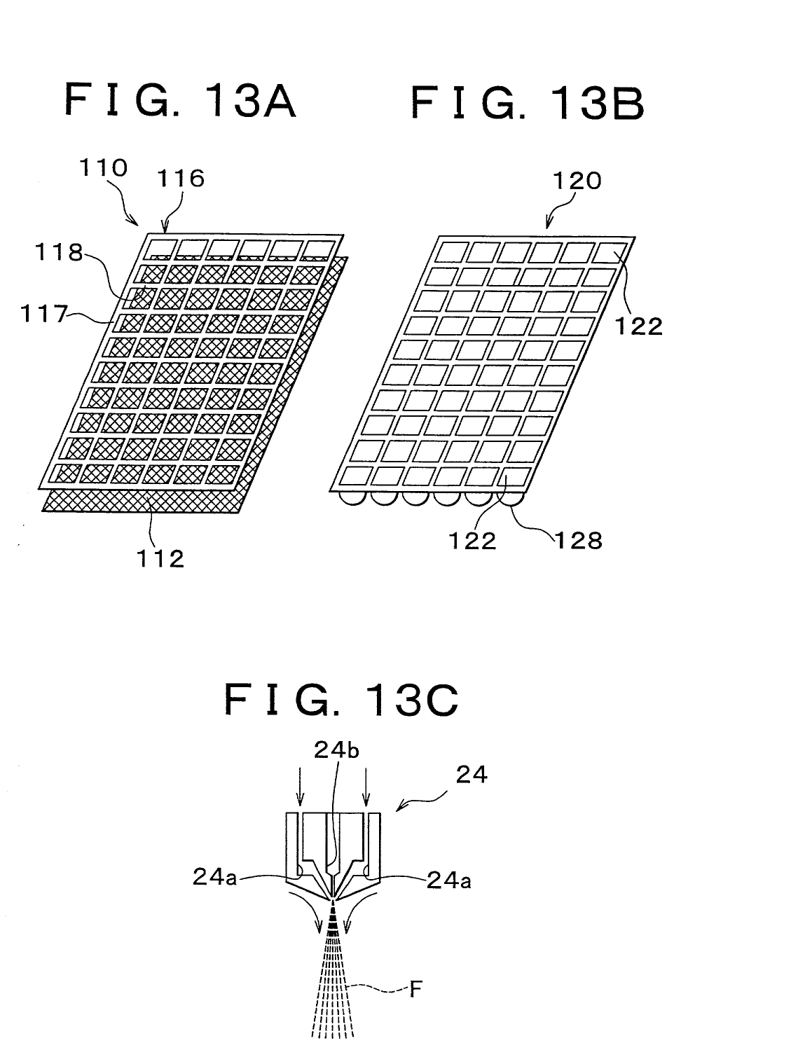

FIGS. 13A, 13B and 13C show modifications of the filter and the manufacturing method thereof according to the present embodiment. A filter 120 of FIG. 13B is formed with the same forming mold 110 and the same spinning nozzle 24 as those of the filter 100. However, the spinning nozzle 24 spins the fibers F at a sufficiently lower rate than that of the filter 100. This prevents the fibers F spun from the spinning nozzle 24 from reaching the bottom plate 112 of the forming mold 110. The filter 120 thus formed has shorter rectangular columnar portions 122 (hanging fiber walls), and each rectangular columnar portion 122 has a substantially hemispherical bottom 128.

As shown in FIG. 13C, the spinning nozzle 24 spins the non-woven fibers F by blowing the hot air from hot-air injection ports 24a to the molten resin injected from a resin injection port 24b located in the center of the spinning nozzle 24. By blowing the hot air at a reduced rate, the fibers F are spun at a reduced rate. As the spinning rate is reduced, extension of the fibers F is reduced and the diameter of the fibers F is increased.

On the contrary, by blowing the hot air at an increased rate, the fibers F are spun at an increased rate. As a result, extension of the fibers F is increased and the diameter of the fibers F is reduced.

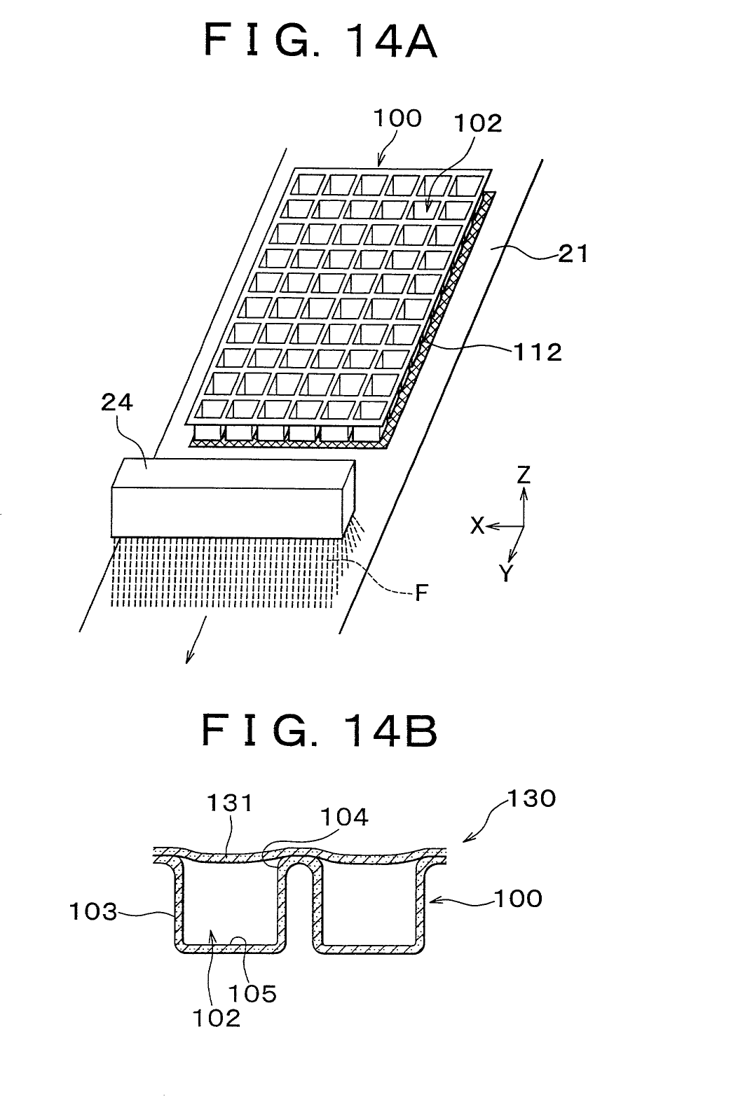

A filter 130 of FIG. 14B corresponds to the filter 100 of FIG. 11B with its openings 104 closed with a sheet-like non-woven fabric 131. Since the openings 104 are closed with the non-woven fabric 131, the filter 130 has a further improved strength.

The filter 130 is formed as shown in FIG. 14A. More specifically, the filter 100 is placed on the conveyor 21 and passed under the spinning nozzle 24 at a constant speed. In order to prevent a layer of fibers F (non-woven fabric 131) covering the openings 104 of the filter 100 from hanging down within the openings 104, the spinning rate of the spinning nozzle 24 is set to a relatively low value. Note that the fibers F covering the openings 104 of the filter 100 are fusion-bonded to the fibers F of the filter 100. The filter 100 may be placed on the conveyor 21 either together with the forming mold 110 or after being removed from the forming mold 110.

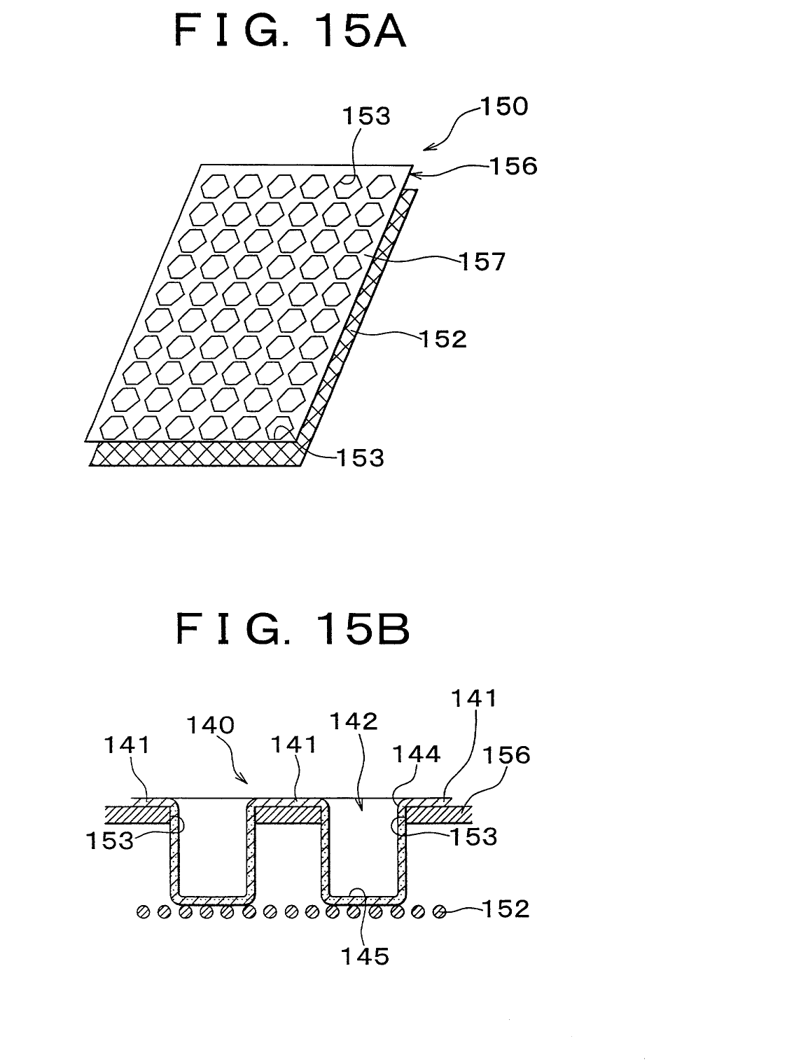

A filter 140 of FIG. 15B includes a plurality of hexagonal columnar portions 142 arranged at prescribed intervals and a connecting plate 141 connecting the opening edges of the hexagonal columnar portions 142. Each hexagonal columnar portion 142 is formed like a bottomed container having its one end opened, and is formed from a main body 142, an opening 144 and a bottom 145. Accordingly, the filter 140 has an improved strength like the filter 100, and thus is less likely to be deformed by the negative pressure of the filter passing therethrough.

A forming mold 150 for forming the filter 140 includes a flat bottom plate 152 and a plate-like forming portion 156 arranged in parallel therewith. The bottom plate 152 is the same as the bottom plate 112 for forming the filter 100. The forming portion 156 corresponds to a flat plate portion 157 with a plurality of hexagonal openings 153 formed at prescribed positions thereof The forming portion 156 is formed from, e.g., punching metal. Note that a mechanism for retaining the forming portion 156 in parallel with the bottom plate 152 at a prescribed height is not shown in the figure. The forming portion 156 may be formed from a fine wire mesh or the like instead of a flat plate.

The forming portion 156 can be regarded as a first plate member of the invention, and the opening 153 can be regarded as a closed loop of the invention.

By using the forming mold 150, the hexagonal columnar portions 142 of the filter 140 are formed by the fibers F hanging down in the openings 153 of the forming portion 156 and the fibers F stacked on the bottom plate 152. Moreover, the connecting plate 141 of the filter 140 is formed by the fibers F stacked on the flat plate portion 157 of the forming portion 156. Note that the spinning rate of the spinning nozzle 24 is set so that the fibers F can reach the bottom plate 152 of the forming plate 150.

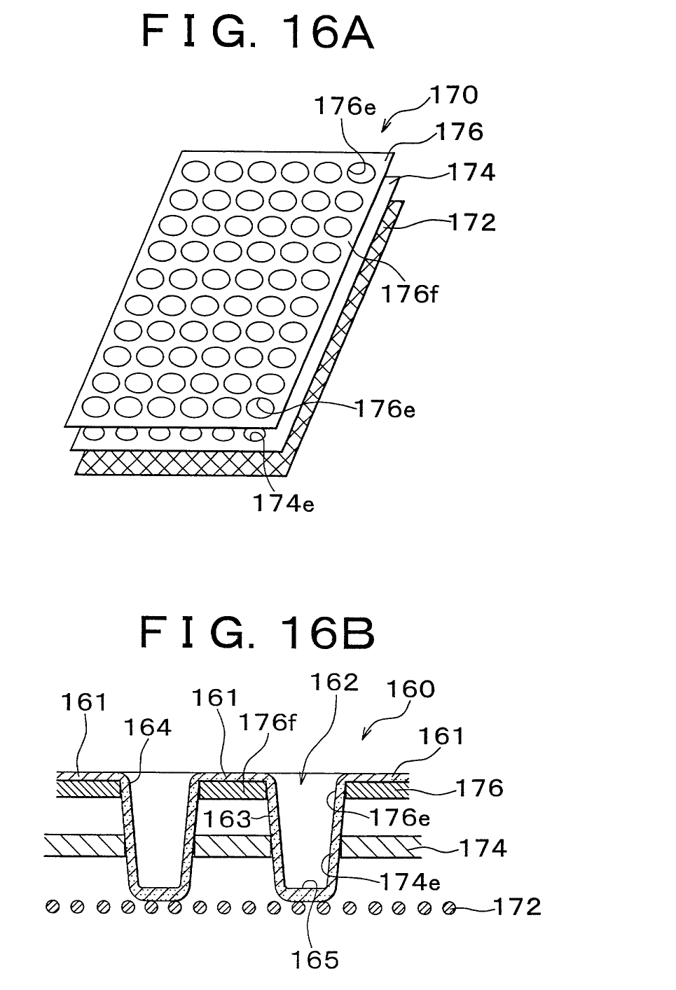

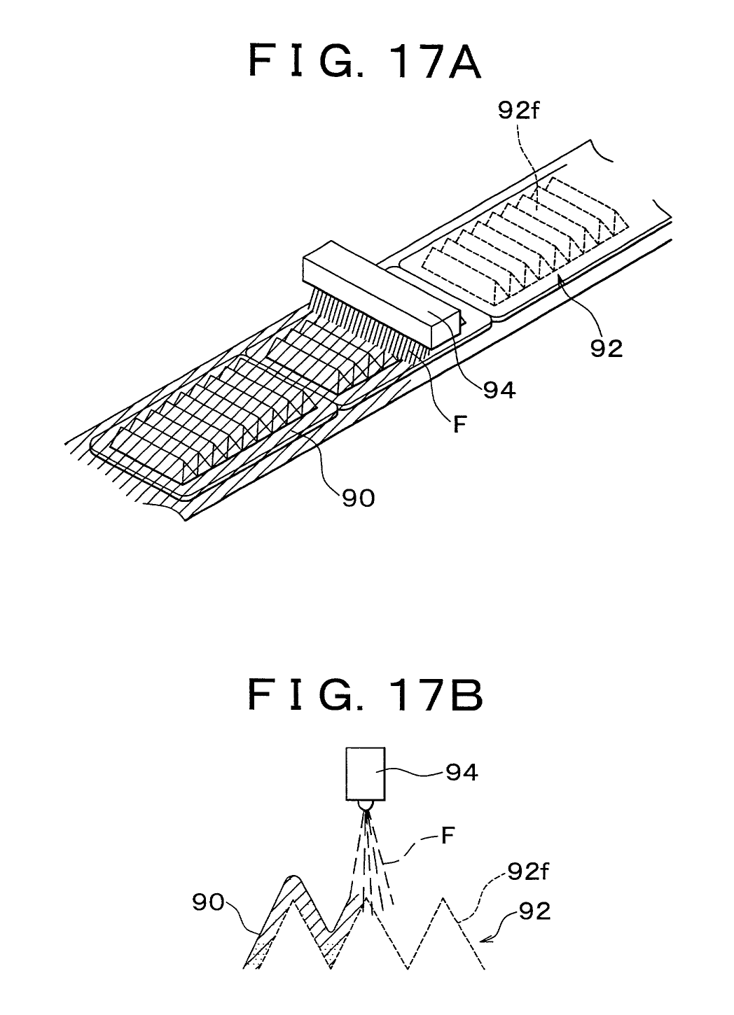

A filter 160 of FIG. 16B includes a plurality of cylindrical portions 162 arranged at prescribed intervals and a connecting plate 161 connecting the opening edges of the cylindrical portions 162. Each cylindrical portion 162 is formed like a bottomed container having its one end opened, and is formed from a main body 163 having a diameter reduced toward its bottom, an opening 164 and a bottom 165. Therefore, the filter 160 has an improved strength like the filter 140, and is less likely to be deformed by the negative pressure of the fluid passing therethrough.

A forming mold 170 for forming the filter 160 includes a flat bottom plate 172, and first and second forming portions 174, 176 having a shape of a flat plate and arranged in parallel with the bottom plate 172. The bottom plate 172 is the same as the bottom plate 112 for forming the filter 100. The first forming portion 174 can be regarded as a first plate member of the invention. The second forming portion 176 can be regarded as a second plate member of the invention.

The first forming portion 174 can be placed above the bottom plate 172. The first forming portion 174 has a plurality of first circular openings 174e at prescribed position of the flat plate portion in order to form the bottom portion of the cylindrical portion 162 of the filter 160. The first circular openings 174e have a relatively small diameter.

The second forming portion 176 can be placed above the first forming portion 174. The second forming portion 176 has a plurality of second circular openings 176e at prescribed positions of the flat plate portion in order to form the opening portion of the cylindrical portion 162 of the filter 160. The second circular openings 176e have a diameter larger than that of the first circular openings 174e.

The first forming portion 174 and the second forming portion 176 are positioned above the bottom plate 174 so that the respective first circular openings 174e and second circular openings 176e are aligned coaxially.

The first forming portion 174 and the second forming portion 176 are commonly formed from, e.g., punching metal. However, the first forming portion 174 and the second forming portion 176 may be formed from a fine wire mesh in place of from the punching metal.

By using the forming mold 170, the cylindrical portions 162 of the filter 160 are formed by the fibers F hanging down from the first circular openings 174e of the first forming portion 174 and the second circular openings 176e of the second forming portion 176 and the fibers F stacked on the bottom plate 172. Moreover, the connecting plate 161 of the filter 160 is formed by the fibers F stacked on the flat plate portion 176f of the second forming portion 176. Note that the spinning rate of the spinning nozzle 24 is set so that the fibers F can reach the bottom plate 172 of the forming plate 170.

Note that, in the third embodiment, the forming mold 110, 150, 170 is formed from the bottom plate 112, 152, 172 and the forming portion 116, 156, 174. However, the bottom plate 112, 152, 172 may be omitted by adjusting the spinning rate of the spinning nozzle 24.

In the third embodiment, the filter is finally removed from the forming mold. However, in the case where the forming portion is formed from a light-weight material, the forming portion may be integrated with the filter.

In the first to third embodiments, a filter is formed as an example of the three-dimensional non-woven fabric. However, the three-dimensional non-woven fabric may alternatively be used as a buffer material and an acoustic material. Furthermore, a columnar portion includes a cylindrical portion.

In the above-mentioned embodiments, for example, the non-woven fabric that is formed from the fibers F on the line-shaped members 36 can be regarded as a first portion of the invention, and the non-woven fabric formed from the fibers F hung dawn from the fibers F on the line-shaped members 36 can be regarded as a second portion of the invention, in the FIG. 1B. In the FIG. 5, the non-woven fabric that are formed from the fibers F on the line-shaped member 56c and the rectangular meshes 56m can be regarded as a first portion of the invention, and the non-woven fabric formed from the fibers F hung dawn from the fibers F on the line-shaped member 56c and the rectangular meshes 56m can be regarded as a second portion of the invention. In the FIG. 12A, the opening edges of the rectangular columnar portions 102, i.e., the non-woven fabric formed from the fibers F on the outer frame 117 and the line-shaped members 118 can be regarded as a first portion of the invention, and the main body 103 can be regarded as a second portion of the invention. In the FIG. 15B, the non-woven fabric formed from the fibers F on the forming portion 156 can be regarded as a first portion of the invention, and the non-woven fabric formed from the fibers F hung dawn from the fibers F on the forming portion 156 can be regarded as a second portion of the invention. In the FIG. 16B, the non-woven fabrics formed from the fibers F on the first forming portion 174 and the second forming portion 176 can be regarded as a first portion of the invention, and the non-woven fabrics formed from the fibers F hung dawn from the fibers F on the first forming portion 174 and the second forming portion 176 can be regarded as a second portion of the invention.

That is, the non-woven fabric formed from semi-molten fibers on a mold can be regarded as a first portion of the invention, and the non-woven fabric formed from semi-molten fibers hung dawn from the semi-molten fibers on the mold can be regarded as a second portion of the invention.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

What is claimed is:

1. A three-dimensional non-woven fabric, comprising:
at least one first portion formed from semi-molten fibers placed on a surface of a mold; and
at least one second portion formed from semi-molten fibers hanging down from the at least one first portion in a tangled state, whereby the at least one second portion is formed in wall-shape, wherein the three-dimensional non-woven fabric is formed by spinning the semi-molten fibers onto the mold.

2. The three-dimensional non-woven fabric according to claim 1, wherein the three-dimensional non-woven fabric is a filter having a filtering portion, and the filtering portion includes a plurality of wave-shaped portions, with the at least one second portion crossing the wave-shaped portions.

3. The three-dimensional non-woven fabric according to claim 1, wherein a plurality of columnar portions formed by the at least one second portion are connected to each other.

4. The three-dimensional non-woven fabric according to claim 3, wherein the plurality of columnar portions have a taper formed by the at least one second portion.

5. The three-dimensional non-woven fabric according to claim 4, wherein each of the plurality of columnar portions has a sidewall and the plurality of columnar portions are connected to each other with their sidewalls shared with each other.

6. The three-dimensional non-woven fabric according to claim 3, wherein each of the plurality of columnar portions has a sidewall and the plurality of columnar portions are connected to each other with their sidewalls shared with each other.

7. The three-dimensional non-woven fabric according to claim 3, wherein each of the plurality of columnar portions has an opening and the plurality of columnar portions are connected to each other at peripheral edges of the openings.

8. The three-dimensional non-woven fabric according to claim 3, wherein the plurality of columnar portions are formed by the at least one second portion as columnar portions having one respective end closed, and the columnar portions are connected to each other so that opening sides and closed sides of adjacent columnar portions are located opposite to each other.

9. A method for manufacturing a three-dimensional non-woven fabric, comprising:
preparing a mold including a portion from which fibers are hanged; and
spinning semi-molten fibers onto the mold so that the semi-molten fibers hang down from the portion of the mold to form a hanging fiber wall.

10. The method according to claim 9, wherein
the mold includes a plurality of closed loops connected to each other; and
the semi-molten fibers are spun onto the plurality of closed loops to hang therefrom, wherein the hanging fiber wall is formed as a plurality of columnar hanging fiber walls connected to each other.

11. The method according to claim 10, wherein the mold, including the plurality of closed loops, is a mesh-like member.

12. The method according to claim 10, wherein the mold, including the plurality of closed loops, includes a first plate member having a plurality of openings.

13. The method according to claim 12, further comprising arranging a second plate member, that has openings smaller than the openings of the first plate member, under the first plate member, so that the first plate member and the second plate member do not contact each other and so that the respective openings are arranged substantially coaxially.

14. The method according to claim 11, wherein a height of the hanging fiber wall is adjusted by adjusting a spinning rate of the semi-molten fibers.

15. A filter manufactured by the method according to claim 9.

16. A mold for manufacturing a three-dimensional non-woven fabric, comprising:
a member from which semi-molten fibers are hanged; and
a forming portion onto which a main body of the three-dimensional non-woven fabric is formed from spun semi-molten fibers.

17. A filter manufactured by the mold according to claim 16.
